(19) United States
(12) Patent Application Publication
(10) Pub. No.: US 2001/0047289 A1
(43) Pub. Date: Nov. 29, 2001

(54) System, method, and computer program product for administering a distribution channel for the promotion and sale of products and services

(75) Inventors: Andrew O. Mckee, Arlington, MA (US); John F. Page, Swampscott, MA (US); Karin L. Dodson, Boston, MA (US); Alexander M. Hehmeyer, Boston, MA (US); Robert F. Heiser, Alexandria, VA (US); Stuart Cohen, Pompton Lakes, NJ (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: VACATION. COM CORPORATION, ALEXANDRIA, VA

(21) Appl. No.: 09/832,787

(22) Filed: Apr. 12, 2001

Related U.S. Application Data
(60) Provisional application No. 60/197,406, filed on Apr. 14, 2000.

(51) Int. Cl. G06F 17/60

(52) U.S. Cl. 705/9

(57) ABSTRACT

A system, method, and computer program product for administering a distribution channel for the promotion and sale of products and services. Content from vendors is maintained in a central repository and administered by the distribution channel manager. Tools are provided for members of the distribution channel to build their own customized web sites for providing consumers access to the content in the central repository as well as their own proprietary information. Sales leads are generated and tracked and routed to the consortium member agencies.

### CROSS REFERENCE TO RELATED APPLICATION

The present document claims the benefit of the earlier filing date of co-pending U.S. provisional patent application serial No. 60/197,406, entitled “SYSTEM, METHOD AND COMPUTER PROGRAM PRODUCT FOR ADMINISTERING A DISTRIBUTION CHANNEL FOR THE PROMOTION AND SALE OF PRODUCTS AND SERVICES”, filed in the United States Patent and Trademark Office on Apr. 14, 2000, and having common inventors as the present document, the entire contents of which being incorporated herein by reference.

### BACKGROUND OF THE INVENTION

1. Field of the Invention

The present invention is directed to systems, methods, and computer program products for administering a distribution channel for the promotion and sale of products and services.

2. Discussion of the Background

In an independent agency model, franchisee model, or co-op model, agencies are established to serve as a resource for providing the goods or services of many suppliers to consumers. One example of an independent agency model is the travel and vacation industry. By having independent travel agencies, consumers can compare the products offered by a variety of vendors by accessing a single resource, namely, the travel agent. Another benefit derived from the agency model is that the agencies can use their volume of sales to the vendors as leverage for getting better prices on products. Extending that example, it would be advantageous to form an organized distribution channel, or consortium, of small independent agencies, franchisees, or co-ops so as to gain further leverage with the vendors, and therefore, further discounts could be offered to consumers. It would also be advantageous if the members of the distribution channel were provided a mechanism for efficient access to the multiple suppliers of products to the channel.

The administration of a distribution channel can be very time consuming and labor intensive. Using the example of a travel agency consortium, the consortium administrator works with the various vendors to get marketing information on the products being offered by the vendors, packages those materials, reproduces the packages, and distributes the packages to the various consortium member agencies. In general, the use of a distribution channel can be very paper intensive and involve many manual processes such as document production, copying, phone calls, etc. These inefficiencies are experienced not only by the agencies or franchisees, but also the product vendors. Using conventional methods, the product vendors must do independent mailings to thousands of agencies or franchisees in order to promote their products. These expenses of conventional methods of using a distribution channel necessarily reduce the benefits that may be passed on to the consumers.

The challenge, then, as presently recognized, is to develop an approach that will facilitate the efficient use of a distribution channel. It would be advantageous if the approach could be automated such that the flow of information between the vendors and the distribution channel members, as well as the flow of information among the member agencies or franchisees could be facilitated.

### SUMMARY OF THE INVENTION

The inventors of the present invention have recognized that currently no methods, systems, or computer program products are available to efficiently administer a distribution channel from vendors to agencies, franchisees, or co-ops. Accordingly, one object of the present invention is to provide a solution to this problem, as well as other problems and deficiencies associated with using a distribution channel.

The present inventors have also recognized that, by creating a central information source for vendor and distribution channel information, the efficiencies of the distribution channel as a whole can also benefit the individual agencies, franchisees or co-ops themselves through reduced paper work and other overhead and lead to increased sales and profitability. Accordingly, a further object of the present invention is to provide a central information source for content of interest to members of the organized distribution channel.

The inventors of the present invention have also recognized that by providing an information sharing infrastructure for the distribution channel members, those members would be able to share important information such as vendor promotions, and experience with particular products or programs with other members. Accordingly, a further object of the present invention is to provide an infrastructure through which distribution channel members can communicate and share information, which will help to improve the efficiency of their businesses.

To address the above-described and other objects, the present inventors have invented a novel computer-based system, method, and computer program product by which a distribution channel may be administered using a single system tailored to the needs of the distribution channel members.

In one embodiment, the present invention is tailored to the management of a consortium of travel agencies. A single content repository is maintained that includes vendor travel and vacation information. By efficiently managing the consortium, the consortium can include a large number of agencies, which can be used by the consortium as leverage with the vendors to obtain discounts based on volume that would otherwise be unavailable to the individual consortium members. The system also includes an infrastructure to facilitate the cooperation and communication among consortium members. The system also includes a lead management capability that will automatically generate and monitor the follow up of leads. The system also includes tools to enable new consortium members to quickly and easily create their own web site in conjunction with the existing distribution channel web site. Consortium members can use these automated tools to easily create their own World Wide Web presence based on the substantial content of the consortium. The members can customize their web sites and add their own proprietary content if desired.

### BRIEF DESCRIPTION OF THE DRAWINGS

A more complete appreciation of the present invention, and many of the attendant advantages thereof, will be readily obtained as the same becomes better understood by reference to the following detailed description when considered in connection with the accompanying drawings, wherein:

FIG. 1 is a schematic diagram of an electronics portion of the workstations used in the system;

FIG. 2 is a block diagram showing an overall system configuration for one embodiment of the present invention;

FIG. 3 is a diagram showing the software architecture for one embodiment of the present invention;

FIG. 4 is a block diagram showing mechanisms of an agency workstation, a consumer workstation, and a consortium management server shown in FIG. 2;

FIG. 5 shows one example of a data field structure in one embodiment of the present invention;

FIG. 6 is a block diagram showing the interrelationships between vendors, agencies, and consumers in one embodiment of the present invention;

FIGS. 7A-7B is a flow diagram of a process to generate leads in one embodiment of the present invention;

FIG. 8 is a flow diagram of a process to follow up on leads generated according to one embodiment of the present invention;

FIG. 9 is a flow diagram of a process to follow up on leads generated according to an alternative embodiment of the present invention; and

FIG. 10 is a flow diagram of a process to build a custom web site to access to join a distribution channel in one embodiment of the present invention.

### DESCRIPTION OF THE PREFERRED EMBODIMENTS

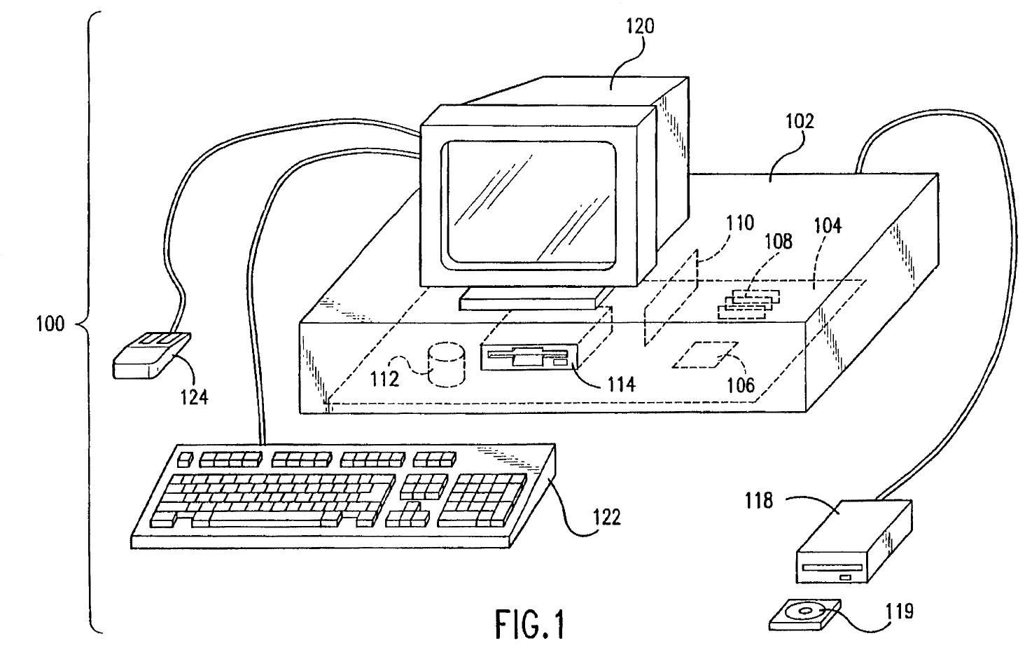

Referring now to the drawings, wherein like reference numerals designate identical or corresponding parts throughout the several views, FIG. 1 is a schematic illustration of a computer system for administering a distribution channel for the promotion and sale of products and services. A computer 100 implements the method of the present invention, wherein the computer housing 102 houses a motherboard 104 which contains a CPU 106, memory 108 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The computer 100 also includes plural input devices, (e.g., a keyboard 122 and mouse 124), and a display card 110 for controlling monitor 120. In addition, the computer system 100 further includes a floppy disk drive 114; other removable media devices (e.g., compact disc 119, tape, and removable magneto-optical media (not shown)); and a hard disk 112, or other fixed, high density media drives, connected using an appropriate device bus (e.g., a SCSI bus, an Enhanced IDE bus, or a Ultra DMA bus). Also connected to the same device bus or another device bus, the computer 100 may additionally include a compact disc reader 118, a compact disc reader/writer unit (not shown) or a compact disc jukebox (not shown). Although compact disc 119 is shown in a CD caddy, the compact disc 119 can be inserted directly into CD-ROM drives which do not require caddies. In addition, a printer (not shown) also provides printed listings of leads or other content maintained by the system.

As stated above, the system includes at least one computer readable medium. Examples of computer readable media are compact discs 119, hard disks 112, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 100 and for enabling the computer 100 to interact with a human user. Such software may include, but is not limited to, device drivers, operating systems and user applications, such as development tools. Such computer readable media further includes the computer program product of the present invention for administering a distribution channel for the promotion and sale of products and services. The computer code devices of the present invention can be any interpreted or executable code mechanism, including but not limited to scripts, interpreters, dynamic link libraries, Java classes, and complete executable programs.

The present embodiment is discussed in the context of the management of a travel agency consortium. However, the invention may be used in other contexts, for example, any independent agent model where an agency is providing goods or services from one or more suppliers to consumers through a distribution channel. The present invention is also applicable to other distribution channel models, including, but not limited to the franchisee model or the co-op model.

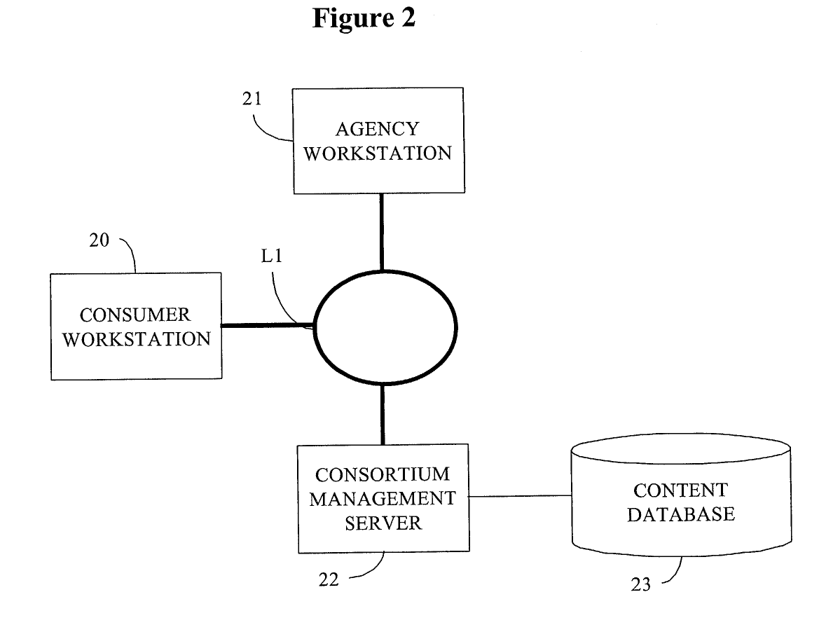

As shown in FIG. 2, the system includes a network L1 including a consumer workstation 20, an agency workstation 21, a consortium management server 22, and a content database 23. The content database 23 is a digital repository that may be implemented, for example, through a commercially available relational database management system (RDBMS) based on the structured query language (SQL) such as, for example, ORACLE, SYBASE, INFORMIX, MICROSOFT ACCESS, or MICROSOFT SQL SERVER, through an object-oriented database management system (ODBMS), or through custom database management software. In one embodiment, the content database 23 contains information of interest to the consortium member travel agencies. For example, the content database 23 includes content from the travel and vacation vendors, as well as information of interest to the consortium itself, including, but not limited to, promotional information and sales leads.

Additionally, the content database 23 may include information from business service suppliers that can be accessed by the consortium members. For example, by leveraging the consortium membership, group rates or discounts could be made available to the consortium members for products and services including, but not limited to, office supplies, insurance, and health plans.

The content database 23 may also include the pages (e.g., COLDFUSION pages, hypertext markup language (HTML) pages, or dynamic HTML (DHTML) pages) through which the users of the system interact via a browser.

The information in the content database 23 is maintained by processes on the consortium management server 22. The content database 23 may reside on a storage device of the consortium management server 22, or reside on another device connected to the consortium management server 22, for example by way of a local area network L1 or other communications link such as a virtual private network, wireless link, or Internet-enabled link.

By maintaining a centralized repository of content, the administration of the distribution channel may be more efficiently accomplished. Distribution channel members including the agencies, franchisees, or co-ops can gain efficient access to large holdings of information from a variety of vendors by accessing a single resource. Furthermore, the vendors can efficiently share information on their products and services with the entire distribution channel with a single transaction, thereby eliminating the need to individually contact each distribution channel member.

The consumer workstation 20 and the agency workstation 21 communicate with the consortium management server 23, for example by way of an extranet L1, although other communications links such as a virtual private network, a wireless link, or an Internet-enabled link may be used as well. An extranet is similar to an intranet, however, one difference is that, with an extranet, access by non-members is permitted, but controlled. In one embodiment of the present invention, the extranet may include further controls imposed by an agency owner to restrict the access of his or her employees to all of the features available on the extranet. Techniques for designing and implementing an extranet are described in various publications such as Bayles, D., “Extranets: Building the Business-To-Business Web,” Prentice Hall Computer Books, 1998, the entire contents of which are incorporated herein by reference. The consumer workstation 20 and the agency workstation 21 interact with the content database 23 through displayable pages accessible through the consortium management server 22 using a commercially available web browser tool including, but not limited to INTERNET EXPLORER, available from Microsoft Corporation and NETSCAPE NAVIGATOR, available from Netscape Communications Corporation. Processes on the consortium management server 22 provide e-mail, bulletin boards, discussion groups, lead information, and other services to consortium member agencies.

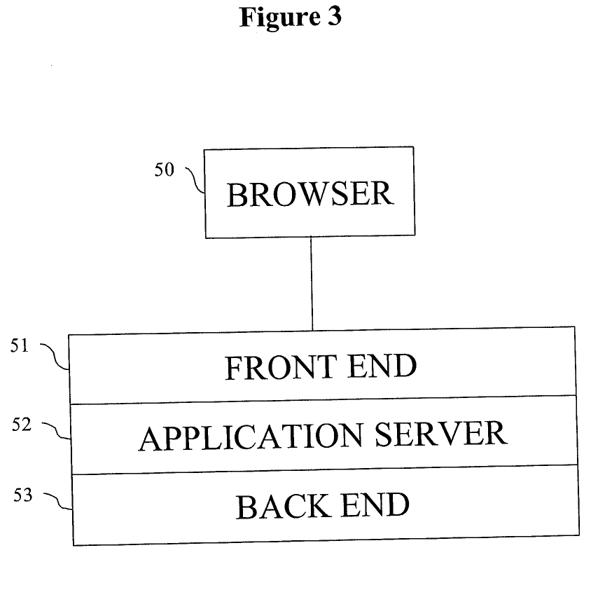

FIG. 3 shows a software architecture used in one embodiment of the present invention. As shown in FIG. 3, the only software requirement for the consumer workstation 20 and the agency workstation 21 to gain access to the system is a commercially available browser 50 such as INTERNET EXPLORER or NETSCAPE NAVIGATOR. By requiring only a browser 50 in order to use the system of the present invention, consumers and agencies of a wide range of technical sophistication may make use of the system of the present invention.

In one embodiment of the present invention, which is described by the inventors as “AgentNet,” the software is developed in a three-tiered architecture. The front end 51 layer of the architecture provides a browsable interface to the system, as discussed above. The consortium itself will have a user interface that will provide access to information including, but not limited to, the travel and vacation information maintained in the content database 23, links to the various vendors providing that information, as well as links to the member agency sites.

Each consortium member agency may also have a customized user interface for providing consumers with access to the same content database 23 as well as additional content provided by the member agency itself. One of the capabilities provided by the present invention is a tool that enables each consortium member agency to create a customized user interface tailored to their desires and including, for example, their logo and contact information. The inventors describe this capability provided by the system of the present invention as the “SiteBuilder” tool. The SiteBuilder tool is a menu driven tool for easily building a customized interface to the consortium content maintained in the content database 23.

All front end layer 51 software including the consortium's user interface as well as the member agencies' user interfaces will be maintained by the consortium through processes of the consortium management server 22. In one embodiment, the user interface is developed in COLDFUSION, available from Allaire Corporation, using techniques available to skilled web programmers, such techniques being described in various publications such as Forta, B., et al., “The ColdFusion 4.0 Web Application Construction Kit,” MacMillan Publishing Company, 1998, the entire contents of which is incorporated herein by reference. Alternate approaches to developing the user interface may be used as well including, but not limited to, dynamic hypertext markup language (DHTML), VISUAL BASIC, extendable markup language (XML), Java, or C++.

The application server layer 52 of the software provides the business logic to interact between the front end layer 51, discussed above, and the back end layer 53. In one embodiment of the present invention, the application server layer 52 is developed in Java and uses the Java database connectivity (JDBC) standard for interacting with the back end layer 53. Alternate approaches to developing the application server layer 52 may also be taken, including, but not limited to, C++, C, or VISUAL BASIC. Connectivity between the application server layer 52 and the back end layer 53 could also be accomplished, for example, through an open database connectivity (ODBC) connection, or an application program interface (API) to the back end layer 53. Techniques for implementing a JDBC connection between the application server layer 52 and the back end layer 53 are described in various publications such as Reese, G., “Database Programming with JDBC and Java,” O'Reilly & Associates, 1997, the entire contents of which are incorporated herein by reference.

The back end layer 53 receives requests from the application server layer 52 and interacts with the content database 23 to satisfy those requests. In one embodiment, the back end is implemented through a commercially available relational database system (RDBMS) such as ORACLE. Alternate approaches to developing the back end layer 53 may also be taken, including, but not limited to, other structured query language (SQL), relational databases such as SYBASE, INFORMIX, or MICROSOFT ACCESS, through an object-oriented database management system (ODBMS), or through custom database management software.

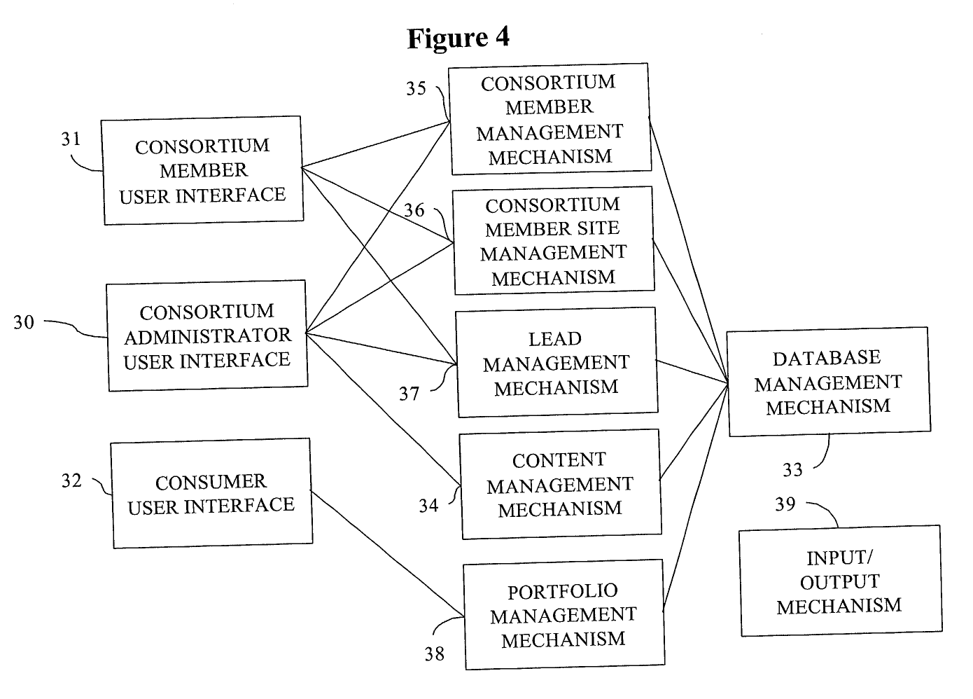

FIG. 4 shows the mechanisms implemented by the software through processes executing on the consumer workstations 20, the agency workstations 21, and the consortium management server 22. The consortium manager maintains the content database 23 and the consortium member sites by accessing the system through a consortium administrator user interface 30. The consortium administrator user interface 30 provides a mechanism through which the consortium manager may maintain the content and the content database 23, facilitate the sharing of information such as sales leads among the consortium member agencies, manage consortium membership, and control the options available to the consortium members on their individual customized sites built by the SiteBuilder tool.

To maintain the content available to the consortium member agencies in the content database 23, a content management mechanism 34 is provided. The content management mechanism 34 is accessible to the consortium manager through the consortium administrator user interface 30. Vendor information that may be stored in the content database 23 may include, but is not limited to, destination information, vacation package information, promotional information regarding promotions available to consortium member agencies, and financial information concerning commission levels. The content management mechanism 34 interacts with the content database 23 through a database management mechanism 33. The database management mechanism 33 is responsible for all interactions with the content database 23. The content management mechanism 34 provides an infrastructure for the efficient distribution of content to all consortium member agencies by making it available in the content database 23, as well as an information sharing infrastructure to allow member agencies to efficiently share information with other members or vendors.

The consortium member management mechanism 35 provides an interface between the consortium and the consortium member agencies. The consortium member management mechanism 35 provides e-mail services, bulletin boards for sharing information among consortium members, and discussion groups for the consortium members. The consortium member management mechanism 35 may also provide special programs to consortium members that can be more efficiently provided by the consortium than by the individual consortium member agencies. As an example, in one embodiment of the present invention, the consortium member management mechanism 35 provides member agencies with the ability to order collateral information (e.g., vendor brochures, newsletters, etc.) online.

As an example, in one embodiment of the present invention, a direct link is provided to computerized reservation systems (CRS) or global distribution systems (GDS) that will enhance the efficiency of the travel agency. In another embodiment, direct booking links are provided that will directly link the agency with the supplier of the product or service.

As another example, a training service is provided to consortium member agencies through the consortium member user interface 31. By accessing the online training, consortium member agencies can receive certifications indicating their level of expertise in a particular geographic area or for a particular vendor product. For example, a travel agency may get certified as being a specialist in a certain geographic area. In one embodiment of the present invention, member agencies create profiles containing their certifications or specialties. These agency profiles may be viewed or searched by either vendors or consumers looking for a particular skill. Furthermore, this service provides a mechanism through which the vendors can efficiently educate the agencies on their products and services so that in turn, the agencies will be better equipped to sell those products and services to consumers. Information regarding certifications or special skills of consortium member agencies may be maintained in the content database 23 through the database management mechanism 33 and made available to consumers accessing the content database 23 through the system of the present invention. Vendors will also be able to access the information maintained in the content database 23. By accessing this information, the vendors will be able to determine which members of the distribution channel, or consortium, have expertise in their particular products and services.

The consortium member management mechanism 35 will maintain an integrated calendar for tracking the exclusive promotional events available to the consortium member agencies as well as the promotions being offered by the consortium vendors. This information can then be made accessible through the agencies' customized sites in an efficient manner. It will be advantageous for the consortium member agencies to have this single resource for this type of information, as well as an efficient means for gaining access to the many vendors providing products to the consortium. By maintaining a promotion calendar for the distribution channel, the members will be able to more efficiently plan their own promotional activities. For example, if a particular travel agency wanted to highlight one of the promotions available to the distribution channel, or consortium, they could order the appropriate brochures in advance of the promotion to have available on their display racks, run advertisements highlighting the promotion in advance, or otherwise plan to take advantage of the promotion.

The consortium member site management mechanism 36 is used by the member agencies to create their own customized World Wide Web site for accessing the information maintained in the content database 23 via a communications network such as the Internet. As discussed above, the consortium member site management mechanism 36 implements the tool described by the inventors as the SiteBuilder tool. The consortium member site management mechanism 36 allows the individual consortium member agencies to benefit from the holdings of the consortium, while maintaining their individualized business presence. The consortium member site management mechanism 36 is accessible to the consortium member agencies through the consortium member user interface 31, and allows the individual consortium member agencies to determine which information from which vendors contained in the content database 23 will be made available through their individual site.

By establishing their own web site through the consortium member site management mechanism 36, the individual consortium member agencies may effectively outsource content management to the consortium, allowing for a more efficient operation than with conventional methods. The information defining the customized member agency site is stored in a content database 23 by the database management mechanism 33.

The SiteBuilder tool also allows the consortium member agencies to add their own proprietary information to their web site. Also, the consortium members may share advertising revenues from advertisements appearing on their web site.

The consumer user interface 32 is the mechanism through which the information maintained in the content database 23 is made available to consumers. Through the consumer user interface 32, consumers are able to choose items from the content database 23, for example, vacations or cruises that are of interest to them. The portfolio management mechanism 38 will maintain this consumer-specific list in the content database 23 through the database management mechanism 33 so that it will be available to the consumer each time he or she accesses the system. The portfolio management mechanism 38 will present the consumer's portfolio on the consumer user interface 32 by sending the appropriate query to the content database 23 through the database management mechanism 33.

The consumer user interface 32 provides a mechanism through which a consumer may view a map showing which consortium member agencies are located near them. In one embodiment, MAPQUEST, available from MapQuest.com is used to display which agencies are located within or near a particular zip code entered by the consumer, however, other geo-spatial querying capabilities may be used. The consumer then has the ability to select a member agency to which sales leads will be forwarded. Alternatively, the consumer may search for a member agency that the consumer is familiar with by performing a search based on the name of the agency.

The lead management mechanism 37 is used to manage and route sales leads among the consortium member agencies based on consumer interactions with the system through the consumer user interface 32. For example, as a consumer adds an item of interest from the content database 23 through the portfolio management mechanism 38, a lead is generated by the lead management mechanism 37. A lead will contain information on the item of interest to the consumer, such as the vacation or destination of interest, as well as profile information about the consumer that the consumer has provided through the consumer user interface 32. The lead information will be stored in the content database 23 by the lead management mechanism 37 through the database management mechanism 33, and forwarded by the lead management mechanism 37 to the agency that was identified by the consumer, as discussed above. The lead management mechanism 37 will then track the lead to verify that the agency receiving the lead has followed up on the lead within a predetermined time limit, for example, 24 hours or 48 hours. If the agency receiving the lead does not follow up on the lead and report back with follow up information within the specified time period, the lead management mechanism 37 will forward a reminder to the agency, and set another predetermined time.

In an alternative embodiment, if the agency does not follow up on the lead and report back with follow up information within the predetermined time after receiving a reminder, the lead may be removed from that agency and forwarded to another member agency by the lead management mechanism 37.

The consortium member user interface 31 is used by the consortium members to communicate and share information with the consortium manager and the vendors. For example, the features provided by the consortium member management mechanism 35, the consortium member site management mechanism 36 and the lead management mechanism 37 would be accessible to the consortium members through the consortium member user interface 31. In one embodiment, the consortium member user interface 31 includes a community section through which the member agencies may communicate with one another. Included in the community section are, for example, bulletin boards, a chat room for special events, among other features.

The input/output mechanism 39 provides a mechanism through which all other mechanisms may interact with external components. For example, the input/output mechanism 39 allows the consumer workstation 20 and the agency workstation 21 to connect to the extranet L1 through a remote connection.

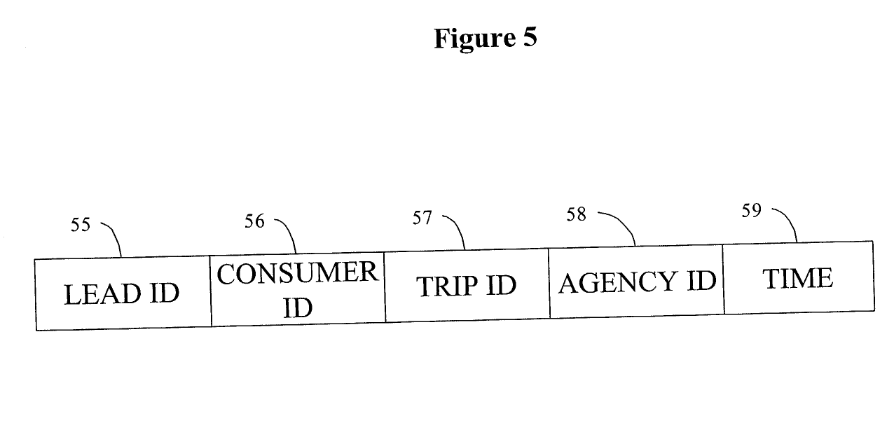

As described above, the system of the present invention generates sales leads that are forwarded to the member agencies. A structure of a message containing a lead, therefore, should include information on the consumer, the product or service of interest to the consumer, the agency to receive the lead, and the time of the lead so that the lead status may be monitored. FIG. 5 shows the structure of one example of a message containing a sales lead. As shown in FIG. 5, the message includes a lead identification field 55, a consumer identification field 56, a field identifying the product of interest to the consumer 57, an identifier for the agency receiving the lead 58, and a time field 59 that can be used to track the status of the lead. Optionally, consumer profile information could be forwarded to the agency along with identification information. The information contained in the lead message may also be maintained in the content database 23 so that the distribution channel manager may track the leads being generated by the system.

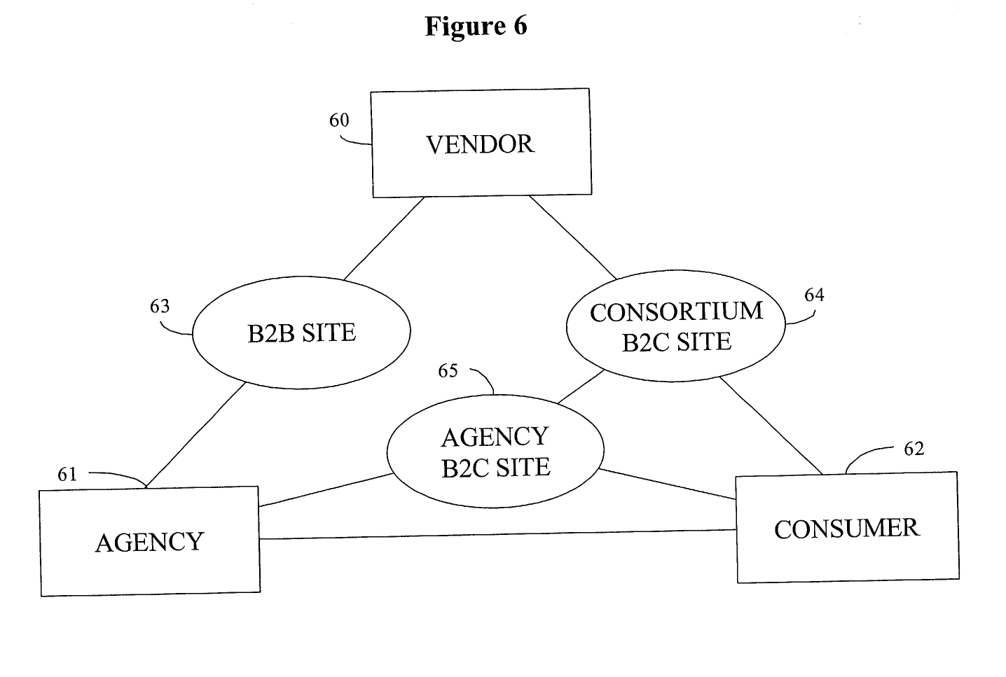

FIG. 6 illustrates the interrelationships between vendors, agencies, and consumers in one embodiment of the present invention. As shown in FIG. 6, the agencies 61 can interact with the vendors 60 through a business-to-business (B2B) site 63. The B2B site 63 provides the agencies 61 with access to the vendor's 60 products. Also, the B2B site 63 allows the vendors 60 to share special vendor promotions with consortium member agencies 61.

The present invention also provides a consortium business-to-customer (B2C) site 64 for linking consumers 62 to vendors 60. The consortium's B2C site 64 provides consumers 62 with access to selected vendor 60 products that are maintained by the consortium in the content database 23. The vendor 60 products are made available through the consortium B2C site 64 and may be added to a consumer's 62 individual portfolio, as described above.

The system also includes an agency business-to-customer (B2C) site 65. The agency B2C site 65 allows an individual consortium member agency to have a customized site for accessing the vendor 60 information maintained by the consortium. As described above, the customized agency B2C site 65 may be built using the SiteBuilder tool. If a particular consortium member agency 61 had a preexisting site, the agency B2C site 65 may be configured to provide a link to that existing site.

As discussed above, the lead management mechanism 37 provides lead information from consumers 62 to consortium member agencies 61. By managing the information flow between vendors 60, consumers 62 and agencies 61, the present invention provides efficiencies not achievable by conventional methods.

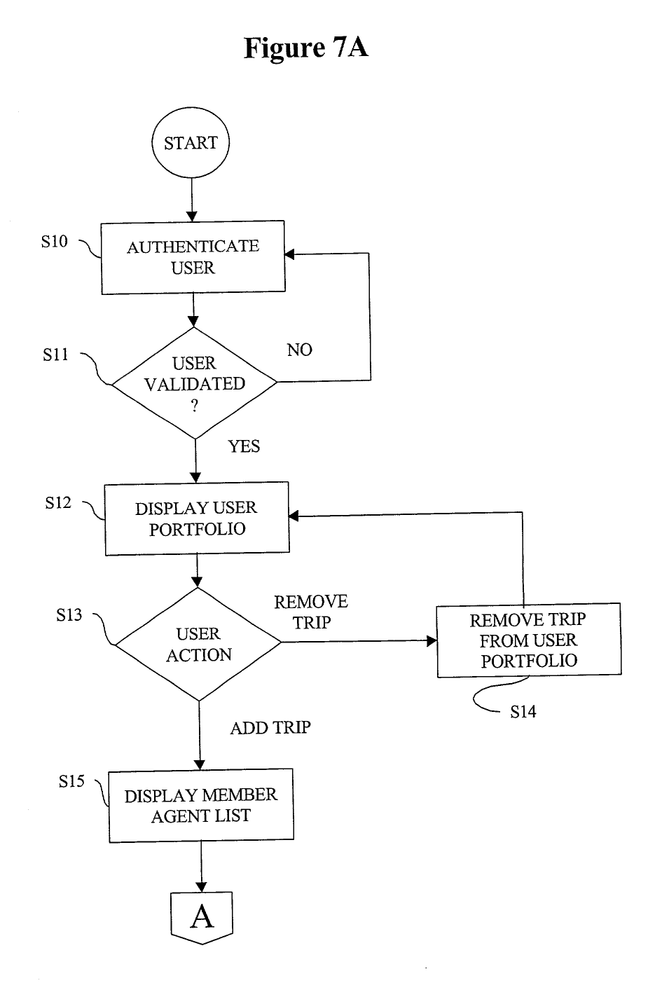

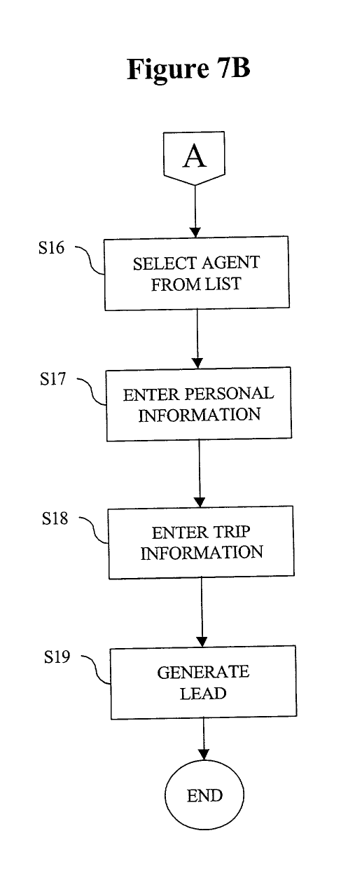

FIGS. 7A-7B are a flow diagram of a process to generate leads according to one embodiment of the present invention. As shown in FIG. 7A, the process begins with step S10 where the user, or consumer, is authenticated. This authentication step S10 is accomplished through the validation of a user ID and password entered by the consumer via the consumer user interface 32. The process then proceeds to step S11 where it is determined whether the user has been validated. If the user has not been validated (i.e., “No” at step S11), the process returns to step S10 where a new user ID and password may be entered by the user. If the user is validated (i.e., “Yes” at step S11), the process proceeds to step S12 where that user's individual portfolio is displayed. The portfolio will include products selected by the consumer in previous sessions. The portfolio includes products selected from the content database 23 and is managed by the portfolio management mechanism 38, described above.

After the consumer's portfolio has been presented to the user via the consumer user interface, the process then proceeds to step S13 where the user action is determined. If the user has requested to remove a trip from his or her portfolio (i.e., “Remove Trip” at step S13), the process proceeds to step S14 where that trip is removed from the user's individual portfolio by the portfolio management mechanism 38. Upon the removal of the trip from the user's portfolio at step S14, the process will proceed back to step S12 where the revised user portfolio is displayed.

If, at step S13, the user desires to add a trip to his or her portfolio (i.e., “Add Trip” at step S13), the process proceeds to step S15 where a list of the consortium member agencies will be displayed. After displaying the list of consortium member agencies at step S15, the process proceeds to step S16, shown in FIG. 7B where the user selects an agent from the list. As described above, the selection of a consortium member agency may be facilitated by a zip code search, or an agency name search, as specified by the user.

After selecting an agent from the list, the process proceeds to step S17 where users are prompted to enter personal profile-type information about them. After adding the personal profile information at step S17, the process proceeds to step S18 where the user is prompted to enter information describing which products are of interest. For example, this information may include destination information, vacation package information, or other information that will help the consortium member agency in assisting the consumer. After the user has entered the information at step S18, the system will generate a lead at step S19. The lead that is generated will include the destination or trip information specified at step S18, the personal profile-type information entered at step S17, and will be forwarded to the consortium member agency selected at step S16.

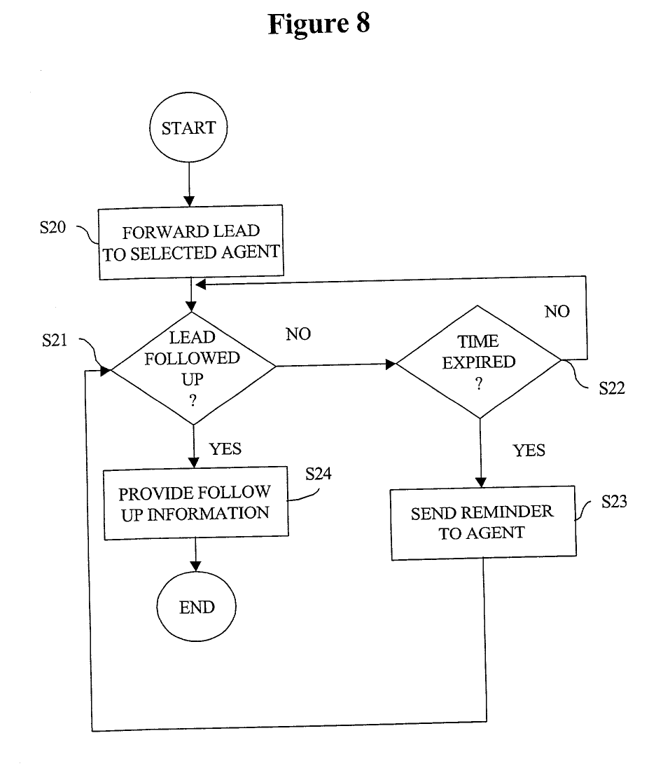

FIG. 8 shows a process through which leads are tracked using one embodiment of the present invention. As shown in FIG. 8, the process begins at step S20 where the lead is forwarded to the consortium member agency that was selected by the consumer. After the selected agency has received the lead, the process proceeds to step S21 where it is determined whether the receiving agency has followed up on the lead. If the lead has not been followed up on (i.e., “No” at step S21), the process proceeds to step S22 where it is determined whether a predetermined time has expired since the agency received the lead. If the predetermined time for responding to the lead has not expired (i.e., “No” at step S22), the process will loop between steps S21 and step S22 where the lead will be monitored until it has either been followed up on, or the predetermined time for responding to a lead has expired. If it has determined that step S22 that the predetermined time for following up on a lead has expired (i.e., “Yes” at step S22), the process proceeds to step S23 where a reminder is sent to the agency that has not yet respond to the lead. After the reminder lead has sent to the agency at step S23, the process will loop between steps S21 and step S22 where the lead will be monitored to assure that it is followed up on. Once it is determined that step S21 that the lead has been followed up on (i.e., “Yes” at step S21), the process proceeds to step S24 where follow up information is provided to the consortium. Once information has been provided showing that the lead has been satisfactorily followed up, the process of monitoring that lead ends. The amount of time that an agency has to follow up on a lead may be configured by the consortium manager.

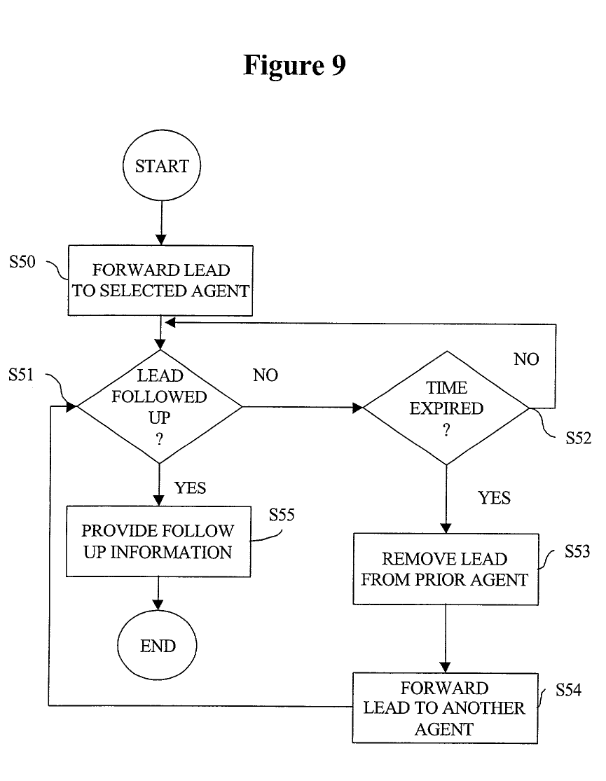

FIG. 9 shows a process through which leads are tracked using one embodiment of the present invention. As shown in FIG. 9, the process begins at step S50 where the lead is forwarded to the consortium member agency that was selected by the consumer. After the selected agency has received the lead, the process proceeds to step S51 where it is determined whether the receiving agency has followed up on the lead. If the lead has not been followed up on (i.e., “No” at step S51), the process proceeds to step S52 where it is determined whether a predetermined time has expired since the agency received the lead. If the predetermined time for responding to the lead has not expired (i.e., “No” at step S52), the process will loop between steps S51 and step S52 where the lead will be monitored until it has either been followed up on, or the predetermined time for responding to a lead has expired. If it has determined that step S52 that the predetermined time for following up on a lead has expired (i.e., “Yes” at step S52), the process proceeds to step S53 where the lead is removed from the agency that did not respond to the lead. The agency may be sent a reminder prior to having the lead removed from them. After the lead has been removed from that agency, the process proceeds to step S54 where the lead is forwarded to another consortium member agency that will have an opportunity to follow up on the lead. After the lead has been forwarded to another agency at step S54, the process will loop between steps S51 and step S52 where the lead will be monitored to assure that it is followed up on. Once it is determined that step S51 that the lead has been followed up on (i.e., “Yes” at step S51), the process proceeds to step S55 where follow up information is provided to the consortium. Once information has been provided showing that the lead has been satisfactorily followed up (i.e., “Yes” at step S51), the process of monitoring that lead ends. The amount of time that an agency has to follow up on a lead may be configured by the consortium manager. Leads that are not followed up on are forwarded to other consortium member agencies in the same geographic vicinity as the original agency selected by the consumer.

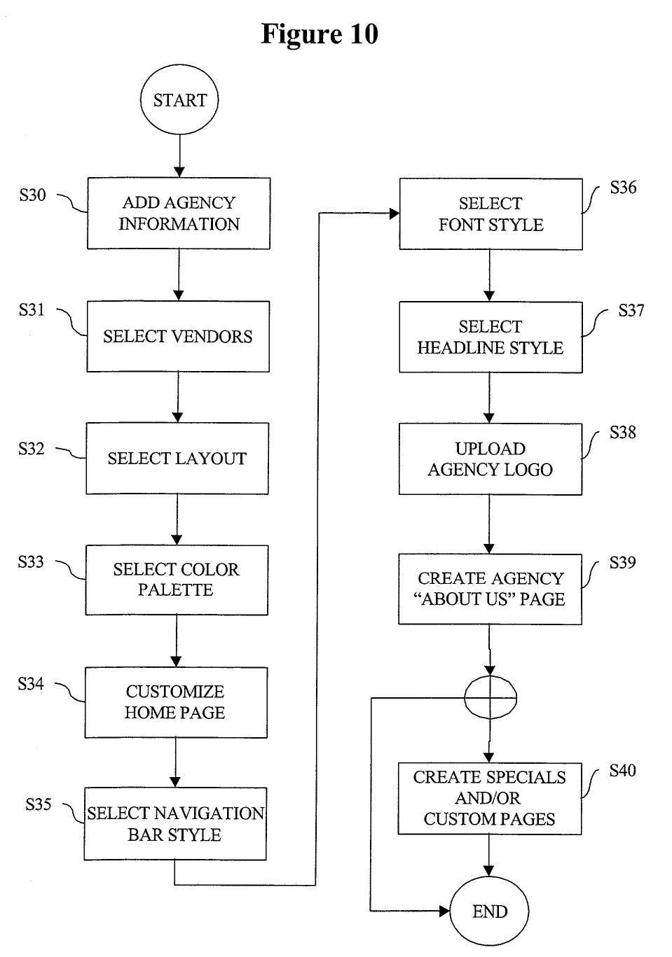

FIG. 10 shows a process through which an agency can create their own web site that integrates with the content database 23 maintained by the distribution channel manager using tools of one embodiment of the present invention. As shown in FIG. 10, the process begins at step S30 where information about the agency creating the web site is added. The information added throughout this process will be maintained by the distribution channel manager in the content database 23. After the agency information has been added, the process proceeds to step S31 where all of the vendors providing products and services to the content database 23 are presented. As step S31, the agency building their web site can either include all vendors, or optionally deselect which vendors that they do not want to appear on their web site. After the vendors have been determined, the process proceeds to step S32 where a layout for the agency web site is selected. A variety of layout styles will be stored in the content database 23 from which the agency may select for their own site. After the layout has been selected, the process proceeds to step S33 where a color pallet is selected. Again, a variety of color pallets for use with the selected layout will be provided as options to the agency. After the color pallet has been selected, the process proceeds to step S34 where the home page may be customized by the agency. After the agency has customized their home page, the process proceeds to step S35 where the agency may select a navigation bar style for their web site. The process then proceeds to step S36 where a font style may be selected for use in their web site. After the font style has been selected, the process proceeds to step S37 where a headline style is selected. After the headline style has been selected, the process proceeds to step S38 where the agency may upload their own agency logo to appear on their web site. After the agency logo has been uploaded, the process proceeds to step S39 where the agency enters “about us” information that will be made available to users of the customized agency site. After the “about us” information has been added, the customized web site is completed. However, the agency may optionally decide to create specials and/or custom pages for their own web site, which can be done at optional step S40.

The processes set forth in the present description may be implemented using a conventional general purpose microprocessor program according to the teachings of the present specification, as will be appreciated to those skilled in the relevant arts. Appropriate software coding can be readily prepared by skilled programmers based on the teachings of the present disclosure, as will also be apparent to those skilled in the relevant arts.

The present invention thus also includes a computer-based product which may be hosted on a storage medium and include instructions that can be used to program a computer to perform a process in accordance with the present invention. The storage medium can include, but is not limited to, any type of disk including floppy disk, optical disks, CD ROMs, magneto-optical disks, ROMs, RAMs, EPROMs, EEPROMs, flash-memory, magnetic or optical cards or any type of media suitable for storing electronic instructions.

Obviously, numerous modifications and variations of the present invention are possible in light of the teachings. It is therefore to be understood that within the scope of the appended claims, the invention may be practiced otherwise than as specifically described herein.

1. A computer implemented system for administering a distribution channel for the promotion and sale of a product, comprising:
a digital repository;
a processor coupled to the digital repository; and
a computer readable medium encoded with processor readable instructions that when executed by the processor implement,
a member management mechanism configured to maintain data in the digital repository corresponding to a member of the distribution channel,
a product management mechanism configured to maintain data in the digital repository corresponding to a product provided by the member,
a consumer interface mechanism configured to provide a consumer with access to data in the digital repository corresponding to the product via a wide area network and to allow the consumer to provide an indicator for the product, and
a lead generating mechanism configured to create a lead including data corresponding to the product and the consumer based on the indicator provided by the consumer, and to forward the lead to the member of the distribution channel via the wide area network.

2. The system of claim 1, wherein the member of the distribution channel is at least one of a vendor, an independent agency, a franchisee, or a co-op member.

3. The system of claim 1, wherein the member of the distribution channel is an independent travel agency.

4. The system of claim 1, wherein the product comprises at least one of a travel-related product and a travel-related service.

5. The system of claim 1, wherein at least a portion of the wide area network comprises an Internet protocol based network.

6. The system of claim 5, wherein at least a portion of the wide area network comprises the Internet.

7. The system of claim 1, wherein the digital repository comprises a database.

8. The system of claim 1, wherein the processor readable instructions comprises at least one of a dynamic link library, a static link library, a script, a COLDFUSION application, a JAVA class, a C++ class, and a C library routine.

9. The system of claim 1, wherein the member management mechanism is further configured to provide a sharing of information among a plurality of members.

10. The system of claim 9, wherein the sharing of information is through at least one of a bulletin board and an e-mail capability.

11. The system of claim 1, wherein the computer readable medium is further encoded with processor readable instructions that when executed by the processor further implement,
a member web site building mechanism configured to provide the member with tools to build a member web site providing access to at least a portion of the digital repository.

12. The system of claim 1, wherein the consumer interface mechanism is further configured to provide the consumer with access to a vendor supplying the product.

13. The system of claim 1, wherein the lead generating mechanism is further configured to send a reminder via the wide area network to the member receiving the lead when the member has not followed up on the lead within a predetermined amount of time.

14. The system of claim 13, wherein the reminder is sent via e-mail.

15. A method for administering a distribution channel for the promotion and sale of a product, comprising the steps of:
populating a digital repository with data relating to a member of the distribution channel;
populating the digital repository with data relating to a product of interest to consumers of the distribution channel, the product being provided by the member;
providing a consumer with access to the digital repository via a wide area network;
identifying the product as being of interest to the consumer;
generating a lead including data corresponding to the product identified in the identifying step and the consumer; and
forwarding the lead generated in the generating step to the member of the distribution channel via the wide area network.

16. The method of claim 15, wherein the member comprises at least one of a vendor, an independent agency, a franchisee, or a co-op member.

17. The method of claim 15, wherein the product comprises at least one of a travel-related product and a travel-related service.

18. The method of claim 15, wherein at least a portion of the wide area network comprises an Internet protocol based network.

19. The method of claim 18, wherein the wide area network comprises the Internet.

20. The method of claim 15, wherein the digital repository comprises a database.

21. The method of claim 15, further comprising the step of building by the member a web site providing access to the digital repository using a tool provided by a manager of the distribution channel.

22. The method of claim 15, further comprising the step of commuunicating by the member with another member of the distribution channel via the wide area network using a tool provided by a manager of the distribution channel.

23. The method of claim 22, wherein the tool comprises at least one of a bulletin board and an e-mail capability.

24. The method of claim 15, further comprising the step of sending the member receiving the lead in the forwarding step a reminder via the wide area network if the lead has not been followed up on within a predetermined amount of time.

25. The method of claim 24, wherein the reminder comprises an e-mail message.

26. The method of claim 15, further comprising the step of providing a consumer with direct access to the member providing the product.

27. The method of claim 15, wherein the product comprises a special promotion being offered to consumers of the distribution channel.

28. The method of claim 15, further comprising the step of ordering by the member collateral material from a vendor of the product.

29. The method of claim 28 wherein the collateral material comprises a brochure relating to the product.

30. The method of claim 15, further comprising the step of order by the member collateral material from a manager of the distribution channel.

31. The method of claim 30, wherein the collateral material comprises at least one of a periodical provided by the manager and a calendar of promotions being offered by the distribution channel.

32. The method of claim 15, further comprising the step of populating the digital repository with information relating to at least one of a certification and a specialization of the member.

33. The method of claim 32, further comprising the step of querying by the consumer for a desired member based on the information in the digital repository relating to the at least one of the certification and the specialization of the member.

34. The method of claim 15, further comprising the step of querying by the consumer for a desired member based on at least one of a member geographic location and a member name.

35. A system for administering a distribution channel for the promotion and sale of a product, comprising:
means for populating a digital repository with data relating to a member of the distribution channel;
means for populating the digital repository with data relating to a product of interest to consumers of the distribution channel, the product being provided by the member;
means for providing a consumer with access to the digital repository via a wide area network;
means for identifying the product as being of interest to the consumer;
means for generating a lead including data corresponding to the product identified by the means for identifying and the consumer; and
means for forwarding the lead generated by the means for generating to the member of the distribution channel via the wide area network.

36. A computer program product, comprising:
a computer storage medium; and
a computer program code mechanism embedded in the computer storage medium for causing a computer to manage a distribution channel for the promotion and sale of a product, the computer program code mechanism having,
a first computer code device configured to maintain data in a digital repository relating to a member of a distribution channel;
a second computer code device configured to maintain data in the digital repository relating to a product provided by the member;
a third computer code device configured to provide a consumer with access to the digital repository via a wide area network;
a fourth computer code device configured to enable the consumer to indicate that the product is of interest;
a fifth computer code device configured to create a lead including data corresponding to the product and the consumer; and
a sixth computer code device configured to send the lead to the member via the wide area network.

37. The computer program product of claim 36, wherein the member comprises at least one of a vendor, an independent agency, a franchisee, or a co-op member.

38. The computer program product of claim 36, wherein the product comprises at least one of a travel-related product and a travel-related service.

39. The computer program product of claim 36, wherein the digital repository comprises a database.

40. The computer program product of claim 36, wherein at least a portion of the wide area network comprises the Internet.

41. The computer program product of claim 36, wherein the computer program code mechanism further having,
a seventh computer code device configured to enable the member to create a web site for accessing the data in the digital repository.

42. The computer program product of claim 36, wherein the computer program code mechanism further having,
a seventh computer code device configured to enable the member to communicate with another member of the distribution channel via the wide area network.

43. The computer program product of claim 36, wherein the sixth computer code device is further configured to send the member a reminder via the wide area network when the lead has not been followed up on within a predetermined amount of time.

44. The computer program product of claim 36, wherein the third computer code device is further configured to provide the consumer with access to the member providing the product via the wide area network.

45. The computer program product of claim 36, wherein the computer program code mechanism further having,
a seventh computer code device configured to enable the member to order collateral material from a vendor of the product via the wide area network.

46. The computer program product of claim 45, wherein the collateral material comprises a brochure relating to the product.

47. The computer program product of claim 36, wherein the computer program code mechanism further having,
a seventh computer code device configured to enable the member to order collateral material from a manager of the distribution channel via the wide area network.

48. The computer program product of claim 47, wherein the collateral material comprises at least one of a periodical provided by the manager and a calendar of promotions being offered by the distribution channel.

49. The computer program product of claim 36, wherein the computer program code mechanism further having,
a seventh computer code device configured to enable the member to populate the digital repository with information relating to at least one of a certification and a specialization of the member.

50. The computer program product of claim 49, wherein the computer program code mechanism further having,
an eighth computer code device configured to enable the consumer to query for a desired member based on information in the digital repository relating to the at least one of the certification and the specialization of the member.

51. The computer program product of claim 36, wherein the computer program code mechanism further having,
a seventh computer code device configured to enable the consumer to query the digital repository for a desired member based on at least one of a member geographic location and a member name.

52. The computer program product of claim 36, wherein the computer program code mechanism further having,
a seventh computer code device configured to enable the member to complete requisite training for receiving a certification.
